(19) United States
(12) Patent Application Publication
(10) Pub. No.: US 2018/0081452 A1
(43) Pub. Date: Mar. 22, 2018

(54) TOUCH INPUT APPARATUS AND VEHICLE INCLUDING THE SAME

(71) Applicant: HYUNDAI MOTOR COMPANY, Seoul (KR)

(72) Inventors: Jungsang MIN, Seoul (KR); Sihyun JOO, Seoul (KR); Jeong-Eom LEE, Yongin-si (KR); Jongmin OH, Suwon-si (KR); Gi Beom HONG, Bucheon-si (KR)

(21) Appl. No.: 15/373,183

(22) Filed: Dec. 8, 2016

(30) Foreign Application Priority Data
Sep. 19, 2016 (KR) 10-2016-0119218

(51) Int. Cl. G06F 3/0362; G06F 3/041; G06F 3/0488; B60K 35/00

(52) U.S. Cl. CPC G06F 3/0362; G06F 3/0414; G06F 3/0412; G06F 3/0416; G06F 3/0488; B60K 2350/104; B60K 2350/1024; B60K 2350/1052; B60K 2350/352; B60K 2350/925; B60K 35/00

(57) ABSTRACT

A touch input apparatus includes: a touch portion configured to receive a touch signal from a user; and a wheel portion disposed along an edge of the touch portion. The wheel portion is rotatable with respect to the touch portion.

### CROSS-REFERENCE TO RELATED APPLICATION

This application claims the benefit of priority to Korean Patent Application No. 10-2016-0119218, filed on Sep. 19, 2016 in the Korean Intellectual Property Office, the entire disclosure of which is incorporated herein by reference.

### TECHNICAL FIELD

Embodiments of the present disclosure relate to a touch input apparatus and a vehicle including the same, and more particularly, to a touch input apparatus including a touch portion and a wheel portion disposed along the edge of the touch portion, and a vehicle including the touch input apparatus.

### BACKGROUND

As electronic and communication technologies have developed, various electronic devices have been manufactured. In the current trend, the aesthetic design of the electronic devices has grown in importance, in addition to a user's operating convenience. According to the current trend, the diversification of an input represented by a keyboard or a keypad is becoming more important.

The input is used in various kinds of display systems, such as a portable terminal, a laptop computer, a smart phone, a smart pad, a smart Television (TV), and the like, which provide a user with information. Recently, with the development of electronic devices, a method of inputting command signals using touch operations is widely used rather than a method of inputting command signals using operation keys, dials, and the like.

A touch input device, which is an input device constituting an interface between a user and an information and communication device using various kinds of displays, enables an interface between an information and communication device and a user when the user directly contacts or approaches close to a touch pad or a touch screen using an input tool, such as his/her finger or a touch pen.

Since a user can use the touch input device by contacting the touch input device with an input tool, such as a finger or a touch pen, the touch input device can be easily used by men and women of all ages. Accordingly, the touch input device is used in various devices, such as Automated Teller Machine (ATM), Personal Digital Assistant (PDA), a mobile phone, etc., and also applied to various fields, such as banks, public offices, sightseeing, traffic guidance, etc.

Recently, efforts to apply touch input devices to health- or medical-related equipment and vehicles are being made. Particularly, the utilization of a touch panel is increasing since it can be used together with a touch screen or independently in a display system. Also, recently, a function of inputting gestures has been developed in addition to a function of moving a point using touch operations.

In regard of a touch input device enabling a user to input gestures, studies into a method of improving the recognition rate of gestures are conducted.

### SUMMARY

Therefore, it is an aspect of the present disclosure to provide a touch input apparatus for providing a physical key function to a wheel portion disposed along the edge of a touch portion to improve a user's convenience and to enable the user to issue various and intuitive commands, and a vehicle including the touch input apparatus.

It is another aspect of the present disclosure to provide a touch input apparatus for providing a physically rotatable wheel portion to provide an immediate feedback to a user, and a vehicle including the touch input apparatus.

It is another aspect of the present disclosure to provide a touch input apparatus capable of improving manipulation sensation or touch sensation when a user inputs a gesture to a touch portion, and a vehicle including the touch input apparatus.

It is another aspect of the present disclosure to provide a touch input apparatus to enable a user to input a gesture intuitively and accurately without putting his/her eyes on a touch portion and a wheel portion, and a vehicle including the touch input apparatus.

Additional aspects of the disclosure will be set forth in part in the description which follows and, in part, will be obvious from the description, or may be learned by practice of the disclosure.

In accordance with one aspect of the present disclosure, a touch input apparatus comprising: a touch portion configured to receive a touch signal from a user; and a wheel portion disposed along an edge of the touch portion; wherein the wheel portion is rotatable with respect to the touch portion.

The touch portion may have a circular shape, and the wheel portion may surround a circumferential edge of the touch portion.

The touch portion may include a concave structure.

The wheel portion may include a convex structure.

The touch portion may be deeper at an inner area relative to an outer area, or it may be maintained at the same depth.

The touch portion may include a concavely curved surface whose inclination becomes gradually smaller toward a central area of the concavely curved surface.

In accordance with other aspect of the present disclosure, a touch input apparatus comprises: a touch portion mounted on an installation surface and configured to receive a touch signal from a user; and a wheel portion mounted on the installation surface along an edge of the touch portion and rotatable with respect to the touch portion.

The wheel portion may be configured to be pressed.

The wheel portion may be configured to be tilted.

The wheel portion may be pressed or tilted by pressure applied by a user so that a signal is input.

The wheel portion may be configured to be tilted in four directions of up, down, left, and right directions or more.

The touch portion may be configured to be pressed with respect to the wheel portion.

The wheel portion and the touch portion may be configured to be pressed by a single button structure, while being preventing from being pressed simultaneously.

The wheel portion may include an inner area extending upward from the circumference of the touch portion, and an outer area extending downward from the top of the inner area.

The inner area may include an inclined surface inclined downward toward the touch portion.

The outer area may include a concavely curved surface.

The wheel portion may be configured to receive a touch signal from the user, and the touch portion and the wheel portion receive touch signals, independently.

The wheel portion may include a plurality of gradations that are engraved or embossed.

The touch input apparatus may further comprise a wrist supporting portion formed at a part of the wheel portion and configured to support the user's wrist, wherein the wrist supporting portion is positioned higher than a touch surface of the touch portion.

In accordance with other aspect of the present disclosure, a vehicle comprising the touch input apparatus, a display apparatus, and a controller configured to operate the display apparatus according to an input signal input to the touch input apparatus.

The controller may convert a gesture input to the touch input apparatus into an input signal, and transmits an operation signal to display operation indicated by the input signal on the display apparatus.

The touch input apparatus is installed in a gear box.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a touch input apparatus according to an embodiment of the present disclosure.

FIG. 2 is a top view of the touch input apparatus for describing a method of manipulating the touch input apparatus according to an embodiment of the present disclosure.

FIG. 3 is a cross-sectional view of the touch input apparatus of FIG. 2, cut along a line A-A.

FIG. 4 shows a trajectory drawn by a user's finger when the user makes a gesture in an up-down direction.

FIG. 5 shows a trajectory drawn by a user's finger when the user makes a gesture in a left-right direction.

FIGS. 6 to 9 are views for describing a method of manipulating the touch input apparatus according to an embodiment of the present disclosure.

FIG. 10 is a cross-sectional view of the touch input apparatus when the touch portion is pressed.

FIG. 11 is a cross-sectional view of the touch input apparatus when the wheel portion is pressed.

FIG. 12 shows a cross-sectional enlarged view of a touch portion according to a first modified embodiment of the present disclosure.

FIG. 13 shows a cross-sectional enlarged view of a touch portion according to a second modified embodiment of the present disclosure.

FIG. 14 is a perspective view of a health machine in which the touch input apparatus according to an embodiment of the present disclosure is installed.

FIG. 15 shows the interior of the vehicle in which the touch input apparatus according to an embodiment of the present disclosure is installed.

FIG. 16 is a perspective view of a gear box in which the touch input apparatus according to an embodiment of the present disclosure is installed.

### DETAILED DESCRIPTION

Hereinafter, embodiments of the present disclosure will be described in detail with reference to the accompanying drawings. The following embodiments are provided to transfer the technical concepts of the present disclosure to one of ordinary skill in the art. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

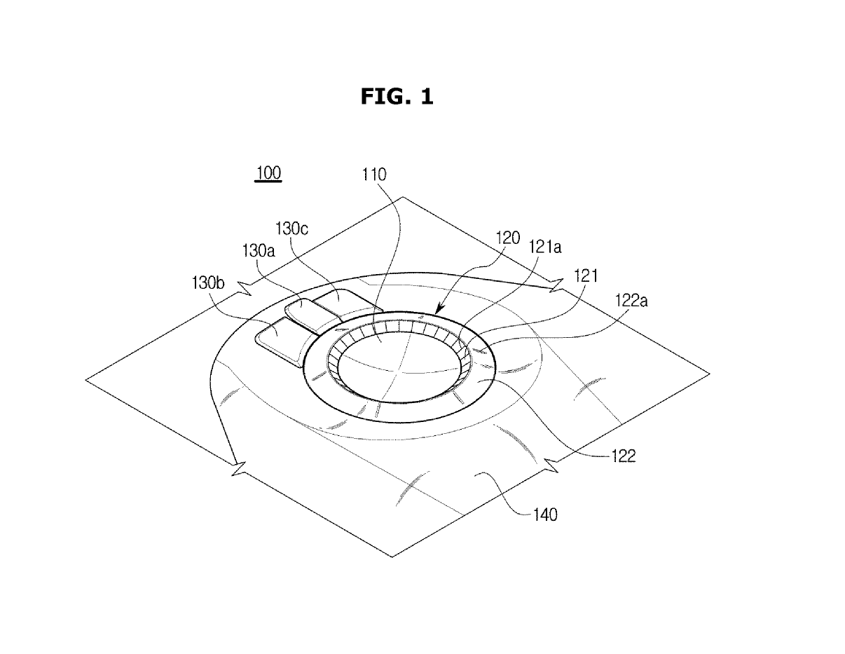

FIG. 1 is a perspective view of a touch input apparatus according to an exemplary embodiment of the present disclosure.

Referring to FIG. 1, a touch input apparatus 100 according to an exemplary embodiment of the present disclosure may be mounted on an installation surface 140, and may include a touch portion 110 and a wheel portion 120 disposed along the edge of the touch portion 110 to surround the touch portion 110. For example, the touch portion 110 may include a circular flat surface, and the wheel portion 120 may be in the shape of a ring.

The touch portion 110 may receive a touch signal from a user. The touch signal may be a simple gesture, such as tapping, dragging, swyping, rotating, scrolling, and pinching, or may be a character, a numeral, or another symbol.

The touch portion 110 may be a touch pad to generate a signal when a user contacts it or approaches close to it using a pointer, such as his/her finger or a touch pen. The user may make a predetermined touch gesture on or above the touch portion 110 to input a desired instruction or command.

The touch pad may be a touch film or a touch sheet including a touch sensor, regardless of its name. Also, the touch pad may be a touch panel which is a display capable of detecting touch operation made on a screen.

The touch operation where a pointer approaches a touch pad so that the pointer is in the proximity of the touch pad without being in contact with the touch pad in order to recognize the location of the pointer is called “proximity touch”, and touch operation where the pointer contacts the touch pad in order to recognize the location of the pointer is called “contact touch”. The location of a pointer at which proximity touch is recognized may be a location at which the pointer approaches a touch pad to be vertical to the touch pad.

The touch pad may be a resistive type touch pad, an optical type touch pad, a capacitive type touch pad, an ultrasonic type touch pad, or a pressure type touch pad. That is, the touch pad may be one of various kinds of touch pads well-known in the art.

The wheel portion 120 may surround the touch portion 110, and may be in the shape of a circular donut or a ring. Also, the wheel portion 120 may be configured to operate independently from the touch portion 110.

The wheel portion 120 may be rotatable. The user may rotate the wheel portion 120 to input a rotation command. Also, the wheel portion 120 may rotate continuously. Also, the wheel portion 120 may rotate in both directions.

Outside the wheel portion 120, a key button or a touch button 130 (130a, 130b, and 130c) may be disposed. The user may input various gestures through the touch portion 110, a rotation command through the wheel portion 120, or a select or cancel command using the button 130.

The touch input apparatus 100 according to an embodiment of the present disclosure may include a wrist supporting portion located below the touch portion 110 and supporting the user's wrist. The support surface of the wrist supporting portion may be positioned higher than the touch surface of the touch portion 110. Thereby, the wrist supporting portion can prevent the user's wrist from being bent upward, when he/she inputs a gesture to the touch portion 110 with his/her finger while putting his/her wrist on the wrist supporting portion. Accordingly, the wrist supporting portion may protect the user from musculoskeletal system disorder, while offering a good operation feeling, when the user repeatedly makes touch inputs.

For example, as shown in FIG. 1, the wrist supporting portion may be integrated into the installation surface 140 in such a way to protrude from the installation surface 140. Or, the wrist supporting portion may be a separate member mounted on the installation surface 140.

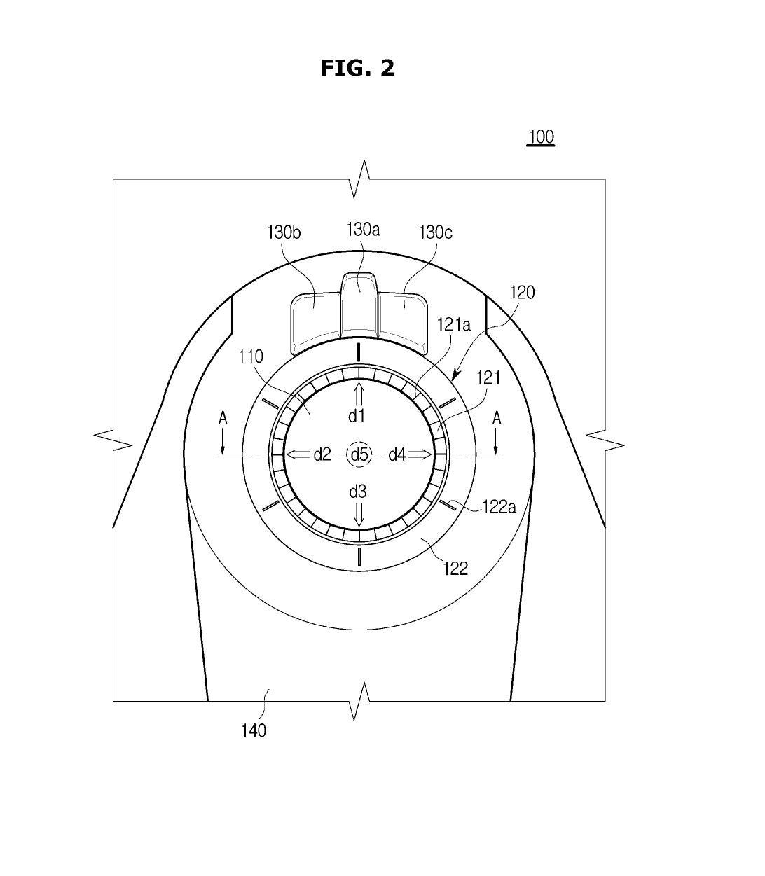

FIG. 2 is a top view of the touch input apparatus 100 for describing a method of manipulating the touch input apparatus 100 according to an embodiment of the present disclosure.

The touch input apparatus 100 according to an embodiment of the present disclosure may include a controller configured to recognize a gesture signal input to the touch portion 110, and to analyze the gesture signal to transfer commands to various devices.

The controller may move a cursor or menu on the display (not shown) according to the location of a pointer moving on the touch portion 110. That is, when the pointer moves from top to bottom, the controller may move a cursor appearing on the display in the same direction, or move a preliminarily selected menu from an upper menu to a lower menu.

Also, the controller may analyze a movement trajectory of the pointer to correspond the movement trajectory to a pre-defined gesture, and execute a command defined for the pre-defined gesture. The gesture may be input when the pointer drags, flicks, rolls, spins, rotates, or taps. Also, the user may input a gesture using various touch input methods.

The dragging or flicking means a touch input method in which the pointer moves in one direction in contact with the touch portion 110, and then leaves the touch portion 110, the rolling means a touch input method in which the pointer draws a circular arc with respect to the center of the touch portion 110, the spinning or rotating means a touch input method in which the pointer draws a circle with respect to the center of the touch portion 110, and the tapping means a touch input method in which the pointer taps the touch portion 110.

Also, the user may input a gesture using a multi-pointer input method. The multi-pointer input method means a method of inputting a gesture in the state in which two pointers contact the touch portion 110 simultaneously or sequentially. For example, a user may input a gesture while touching the touch portion 110 with his/her two fingers. The multi-pointer input method may diversify commands or instructions that a user can input.

The various touch input methods may include a method of inputting an arbitrary promised gesture, as well as a method of inputting a gesture, such as a numeral, a character, or a symbol. For example, the user may input a command by drawing a consonant/vowel of Hangul, an alphabet, an Arabic numeral, or an arithmetic operator on the touch portion 110. The user may draw a character or numeral that he/she wants to input on the touch portion 110, instead of selecting the character or numeral from the display, thereby reducing an input time and providing a more intuitive interface.

The touch portion 110 may be configured to allow pressing operation or tilting operation. The user may apply pressure on the touch portion 110 to press or tilt a part of the touch portion 110, thereby inputting a predetermined execution signal. The pressing operation may include a case of pressing the touch portion 110 evenly and a case of pressing the touch portion slopingly. Also, if the touch portion 110 is flexible, a part of the touch portion 110 may be pressed.

For example, the touch portion 110 may be tilted in at least one direction d1 to d4 with respect to a direction that is vertical to the touch surface. For example, as shown in FIG. 2, the touch portion 110 may be tilted in a front/rear/left/right direction d1 to d4. Also, according to another embodiment, the touch portion 110 may be tilted in more various directions. If the user presses a center area d5 of the touch portion 110, the touch portion 110 may be pressed evenly.

The user may apply pressure to the touch input apparatus 100 to press or tilt the touch input apparatus 100, thereby inputting a predetermined instruction or command. For example, the user may press the center area d5 of the touch portion 110 to select a menu, etc., and press an upper area d1 of the touch portion 110 to move the cursor upward.

Meanwhile, operation of pressing or tilting the touch portion 110 may be applied in the same way to the wheel portion 120.

Also, the touch input apparatus 100 may further include a button input portion 130. The button input portion 130 may be disposed around the wheel portion 120, for example, above the wheel portion 120. Also, since the button input portion 130 is located near the touch portion 110 or the wheel portion 120, the user can operate the button input portion 130 by moving only his/her finger from his/her hand inputting a gesture, thereby quickly issuing an operation command.

The button input portion 130 may include a touch button and a physical button. The touch button may generate a signal when a pointer touches it, and the physical button may generate a signal when its shape is changed by a physical external force. The physical button may include, for example, a clickable button and a tiltable button.

In FIG. 2, three buttons 130a, 130b, and 130c are shown. For example, the buttons 130a, 130b, and 130c may include a Home button 130a to move to a Home menu, a Back button 130b to move from a current screen to the previous screen, and an Option button 130c to move to an Option menu. Also, a Shortcut button to directly move to a predetermined menu may be further provided. The Shortcut button may be used to directly move to a frequently used menu or device designated by the user.

Although not shown in the drawings, the touch input apparatus 100 may install various kinds of components related to operations therein. In the inside of the touch input apparatus 100, a structure for enabling the touch portion 110 and the wheel portion 120 to be pressed or tilted in the above-described five directions d1 to d5 may be installed. Although the structure is not shown in the drawings, it will be able to be easily embodied using a technique generally used in the related art.

Also, in the inside of the touch input apparatus 100, various kinds of semiconductor chips and a Printed Circuit Board (PCB) may be installed. The semiconductor chips may be mounted on the PCB. The semiconductor chips may perform information processing or store data. The semiconductor chips may interpret a predetermined electrical signal generated according to a gesture and pressing operation recognized by the touch portion 110, rotation and pressing operation recognized by the wheel portion 120, or operation of pressing the button input portion 130 provided in the touch input apparatus 100, generate a predetermined control signal according to the result of the interpretation, and then transfer the predetermined control signal to the display or a controller of another apparatus.

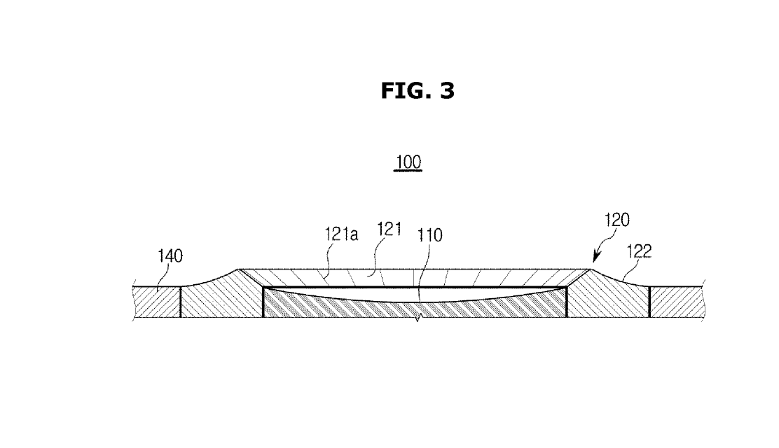

FIG. 3 is a cross-sectional view of the touch input apparatus 100 of FIG. 2, cut along a line A-A.

Referring to FIG. 3, the touch portion 110 may be separated from the wheel portion 120, and the wheel portion 120 may be separated from the installation surface 140. Accordingly, the touch portion 110 may be pressed relatively with respect to the wheel portion 120, and the wheel portion 120 may be pressed relatively with respect to the touch portion 110 and the installation surface 140.

The touch portion 110 may include an area that is lower than a boundary line with the wheel portion 120. That is, the touch surface of the touch portion 110 may be lower than a boundary line between the touch portion 110 and the wheel portion 120. For example, the touch portion 110 may be inclined downward from the boundary line with the wheel portion 120, or may have a step with respect to the boundary line with the wheel portion 120. For example, the touch portion 110 according to an embodiment of the present disclosure, as shown in FIG. 3, may include a curved surface area formed in the shape of a concavely curved surface.

In the drawings, the touch portion 110 may be inclined downward, without having any step with respect to the boundary line with the wheel portion 120. However, the touch portion 110 may be inclined downward, with having a step downward with respect to the boundary line with the wheel portion 120.

Since the touch portion 110 includes an area lower than the boundary line with the wheel portion 120, the user can recognize the area of the touch portion 110 and the boundary line with his/her tactile sensation. If a gesture is made on the center area of the touch portion 110, the gesture can be recognized with a high recognition rate. Also, when similar gestures are input at different locations, the gestures may be recognized as different commands. There may occur a problem when the user inputs a gesture without looking at the touch surface. If the user can intuitively recognize the touch surface and the boundary line with his/her tactile sensation when he/she inputs a gesture while looking at the display or concentrating his/her attention on the external situation, the user will be able to easily input the gesture at an exact location. Accordingly, the input accuracy of the gesture can be improved.

The touch portion 110 may include a concave structure. The concave structure may be an engraved or depressed structure. Also, the concave structure may include a roundish depressed structure, an inclined depressed structure, and a stepped depressed structure.

Also, the touch portion 110 may include a concavely curved structure. For example, the touch portion 110 may be, as shown in the drawings, provided as a concavely curved surface having a predetermined curvature. That is, the touch portion 110 may be in the shape of a part of the inner surface of a sphere. If the touch portion 110 has a constant curvature, a sense of difference felt by the user when the user inputs a gesture to the touch portion 110 can be minimized.

Also, the touch portion 110 may include a concave structure that is gradually deeper toward the inner area from the outer area, or that is maintained at the same depth. That is, the touch portion 110 may have no convex surface. If the touch portion 110 includes a convex surface, a trajectory along which the user can smoothly draw a gesture may become different from the curve of the touch surface, which interferes with the user's accurate touch input. As shown in FIG. 1, the center of the touch portion 110 may be deepest, and the curvature of the touch portion 110 may become smaller gradually at a predetermined rate toward the center from the outer area.

The above-mentioned convex surface does not mean a convex area formed at a part of the touch surface of the touch portion 110, but mean a convex area corresponding to the entire touch surface of the touch portion 110. Accordingly, the touch portion 110 according to the embodiment of the present disclosure may include a small protrusion at the center so that the user can recognize the location of the center with his/her tactile sensation, or may include a thin crease protruding in the shape of a concentric circle.

Also, the curved surface of the touch portion 110 may have different curvatures according to area. For example, the touch portion 110 may have a concavely curved surface whose inclination becomes gradually gentle toward the center area. That is, the center area of the touch portion 110 may have a relatively small curvature (a small radius of curvature), and the outer area of the touch portion 110 may have a relatively great curvature (a great radius of curvature). As such, since the curvature of the center area of the touch portion 110 is smaller than that of the outer area of the touch portion 110, the user can easily input a gesture to the center portion using a pointer. Also, since the curvature of the outer area is greater than that of the center area, the user may sense the curvature by touching the outer area to thereby easily recognize the location of the center area although he/she does not look at the touch portion 110.

In the touch input apparatus 100 according to an embodiment of the present disclosure, since the touch portion 110 includes a concavely curved surface, a user can feel good touch sensation (or good manipulation sensation) when inputting a gesture to the touch portion 110. The curved surface of the touch portion 110 may similarly correspond to a trajectory drawn by a user fingertip's movement occurring when he/she moves his/her finger while fixing his/her wrist or when he/she rotates or twists his/her wrist while spreading out his/her fingers.

The touch portion 110 including the concavely curved surface, according to the embodiment of the present disclosure, is ergonomic compared to a flat touch portion. That is, the touch portion 110 can reduce fatigue that is applied to the user's wrist, etc., while improving the user's touch sensation. Also, the touch portion 110 can improve the accuracy of inputs, compared to a case of inputting gestures to a flat touch portion.

Also, the touch portion 110 may be formed in the shape of a circle. If the touch portion 110 is formed in the shape of a circle, it is easy to form a concavely curved surface. Also, if the touch portion 110 is formed in the shape of a circle, the user can sense the touch area in the shape of the circle with his/her tactile sensation, so as to be able to easily input circular gesture operation such as rolling or spinning.

Also, since the touch portion 110 is provided as a concavely curved surface, the user can intuitively recognize where his/her finger is located on the touch portion 110. Since the touch portion 110 is provided as a curved surface, the inclination of the touch portion 110 may change according to area. Accordingly, the user can intuitively recognize where his/her finger is located on the touch portion 110 through a sense of inclination felt through his/her finger.

This feature may provide a feedback about where the user's finger is positioned on the touch portion 110 when the user inputs a gesture to the touch portion 110 while fixing his/her eyes on any other place than the touch portion 110, so as to help the user input a desired gesture, thereby improving the accuracy of gesture input. For example, when the user feels that the touch portion 110 is flat through a sense of inclination felt by his/her finger, the user can intuitively determine that his/her finger is touching the center area of the touch portion 110. Also, when the user recognizes a direction of inclination of the touch portion 110 felt by his/her finger, the user can intuitively determine which direction his/her finger is positioned in with respect to the center area of the touch portion 110.

Meanwhile, the diameter and depth of the touch portion 110 may be decided in the range of an ergonomic design. For example, the diameter of the touch portion 110 may be selected within a range from 50 mm to 80 mm. The reason is because a range to which a finger can move naturally at once when a wrist is fixed is about 80 mm, in consideration of the average length of an adult's finger. If the diameter of the touch portion 110 exceeds 80 mm, the user may need to move his/her hand unnaturally and use his/her wrist more than necessary when drawing a circle along the edge of the touch portion 110.

In contrast, if the diameter of the touch portion 110 is smaller than 50 mm, the touch area may be reduced so that the user may have difficulties in making various gestures. Also, since a gesture is drawn in a narrow area, gesture input errors may be easily generated.

Also, if the touch portion 110 is formed in the shape of a spherical surface, a depth/diameter value of the touch portion 110 may be selected within a range from 0.04 to 0.1. The value obtained by dividing the depth of the touch portion 110 by the diameter of the touch portion 110 means a degree of bending of the curved surface. That is, as the depth/diameter value is greater at a constant diameter of the touch portion 110, the touch portion 110 may have a more concave shape. In contrast, as the depth/diameter value is smaller at a constant diameter of the touch portion 110, the touch portion 110 may have a flatter shape.

If the depth/diameter value of the touch portion 110 is greater than 0.1, the curvature of the concave surface may increase, resulting in deterioration of a user's touch sensitivity. Accordingly, the curvature of the concave surface may be preferably identical to the curvature of a curve drawn by a user's fingertip when the user moves his/her finger naturally on the touch portion 110. However, if the depth/diameter value exceeds 0.1, the user may get an artificial operation feeling when he/she moves his/her finger along the touch portion 110. Also, when the user moves his/her finger naturally and unconsciously on the touch portion 110, the user's finger may be taken off the touch portion 110. In this case, a gesture may be disconnected so that a recognition error may be generated.

In contrast, if the depth/diameter value of the touch portion 110 is smaller than 0.04, the user cannot get a difference of an operation feeling compared to the case of drawing a gesture on a flat touch unit.

Meanwhile, a touch pad that is used in the touch portion 110 formed in the shape of a curved surface may recognize touch operation using an optical method. For example, in the rear surface of the touch portion 110, Infrared Rays Light Emitting Diodes (IR LEDs) and a photodiode array may be disposed. The IR LEDs and the photodiode array may acquire an IR image reflected by a finger, and the controller may extract a touch point from the acquired image.

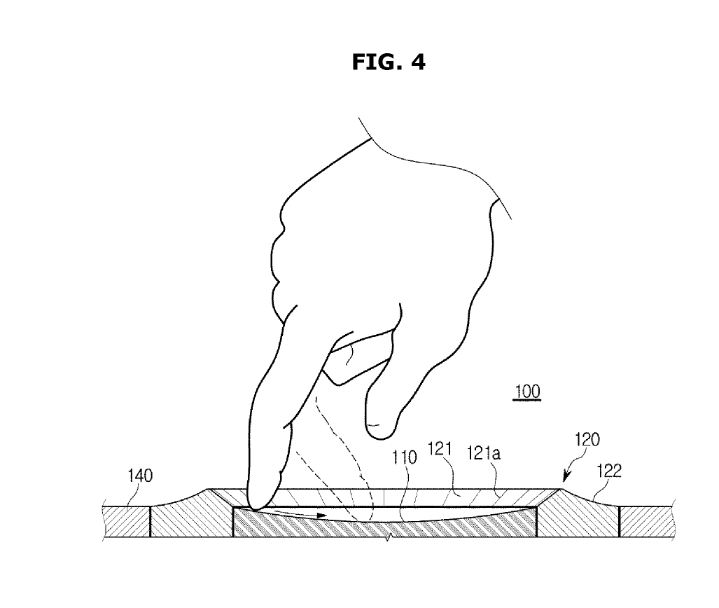

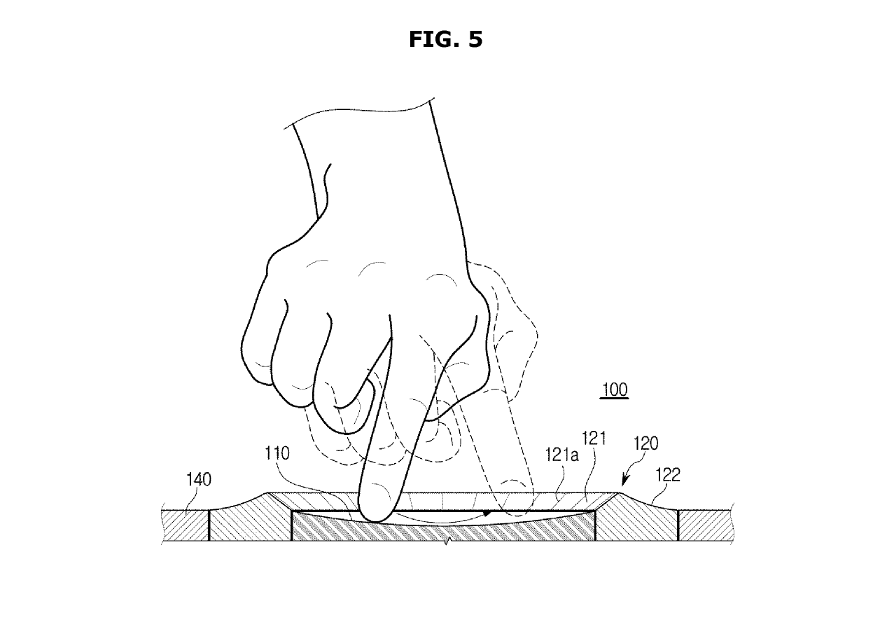

FIG. 4 shows a trajectory drawn by a user's finger when the user makes a gesture in an up-down direction, and FIG. 5 shows a trajectory drawn by a user's finger when the user makes a gesture in a left-right direction.

The touch portion 110 according to an embodiment of the present disclosure may include a concavely curved surface. The curvature of the touch portion 110 may be decided to an appropriate value such that a user can get a comfortable operation feeling when making a gesture on the touch portion 110. Referring to FIG. 4, when a user moves his/her finger in an up-down direction, the user can make a gesture by natural movement of his/her finger without moving or bending any joint except for the finger. Likewise, referring to FIG. 5, when the user moves his/her finger in a left-right direction, the user can make a gesture by natural movement of his/her finger and wrist without twisting his/her wrist excessively. As such, since the touch portion 110 is designed ergonomically, a user may feel low fatigue even when using the touch portion 110 for a long time, while being protected from muscular skeletal diseases that may be generated in his/her wrist or joints.

Hereinafter, the wheel portion 120 will be described in detail.

The wheel portion 120 may include a convex structure outside the touch portion 110. The wheel portion 120 may include an inner area 121 extending upward from the touch portion 110, and an outer area 122 extending downward from the ridge of the wheel portion 120.

The inner area 121 may include a plurality of gradations 121a. The gradations 121a may be formed at equidistant intervals along the circumference of the touch portion 110 in the shape of a circle. The user can visually check a degree of rotation of the wheel portion 120 through the gradations 121a.

The gradations 121a may be engraved or embossed. In this case, the gradations 121a may act as a factor of increasing a friction force against the user's finger to prevent the user's finger from slipping when the user performs rotation operation.

Also, the inner area 121 may be configured to recognize touch inputs. That is, the user may input a command by swyping along or tapping on the inner area 121.

The gradations 121a may be engraved or embossed, as described above. In this case, the user can intuitively recognize an angle to which his/her finger moves, through his/her tactile sensation, without looking at the gradations 121a.

The outer area 122 may include a plurality of catching parts 122a. The catching parts 122a may be arranged at equidistant intervals along the circumference of the touch portion 110 in the shape of the circle. The user can visually check a degree of rotation of the wheel portion 120 through the catching parts 122a.

Also, the catching parts 122a may be engraved or embossed. In this case, the catching parts 122a may act as a factor of increasing a friction force against the user's finger to prevent the user's finger from slipping when the user performs rotation operation.

Also, the outer area 122 may be configured to recognize touch inputs. That is, the user may input a command by swyping along or tapping on the outer area 122.

The catching parts 122a may be engraved or embossed, as described above. In this case, the user can intuitively recognize an angle to which his/her finger moves, through his/her tactile sensation, without looking at the catching parts 122a.

The inner area 121 may be formed as an inclined surface. If the touch portion 11 is formed as a concavely curved surface, and the inner area 121 is formed as an upwardly inclined surface, the user can recognize a difference in inclination between the touch portion 110 and the inner area 121 through his/her tactile sensation to intuitively distinguish the touch portion 110 from the wheel portion 120.

The outer area 122 may be formed as a concavely curved surface. In this case, the curvature of the concavely curved surface may be selected within a range similar to the curvature of a finger's convexly curved surface. Accordingly, when the user tightly contacts the outer area 122 with his/her finger to rotate the wheel portion 120, a contact area of the finger with the outer area 122 can increase. As such, by increasing the contact area of the finger with the outer area 122, it is possible to increase manipulation sensation while preventing the finger from slipping, when the user performs rotation operation.

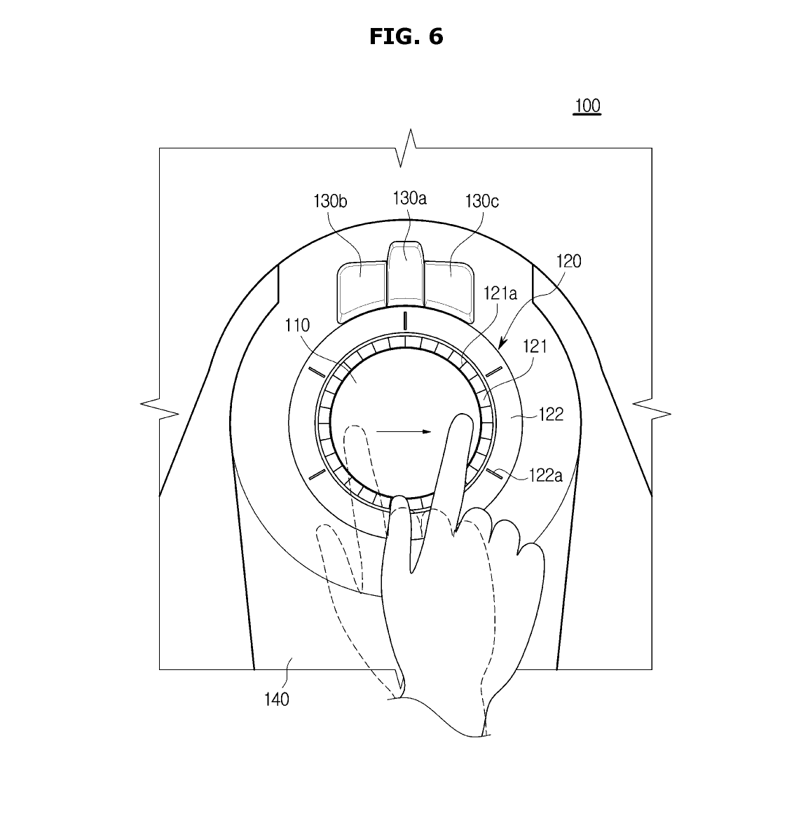

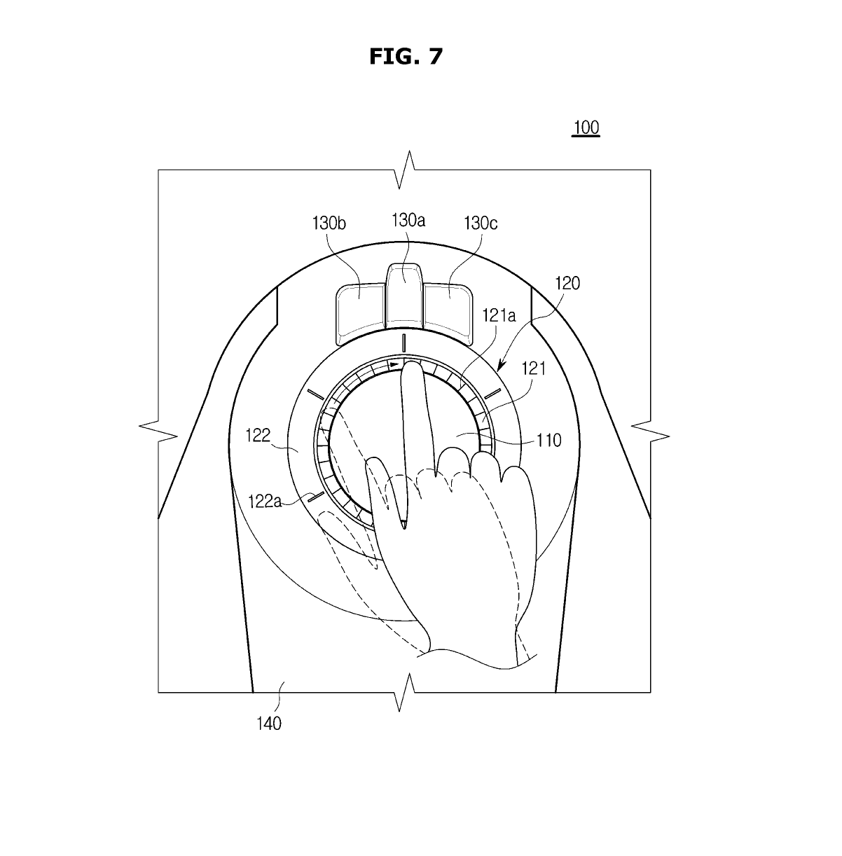

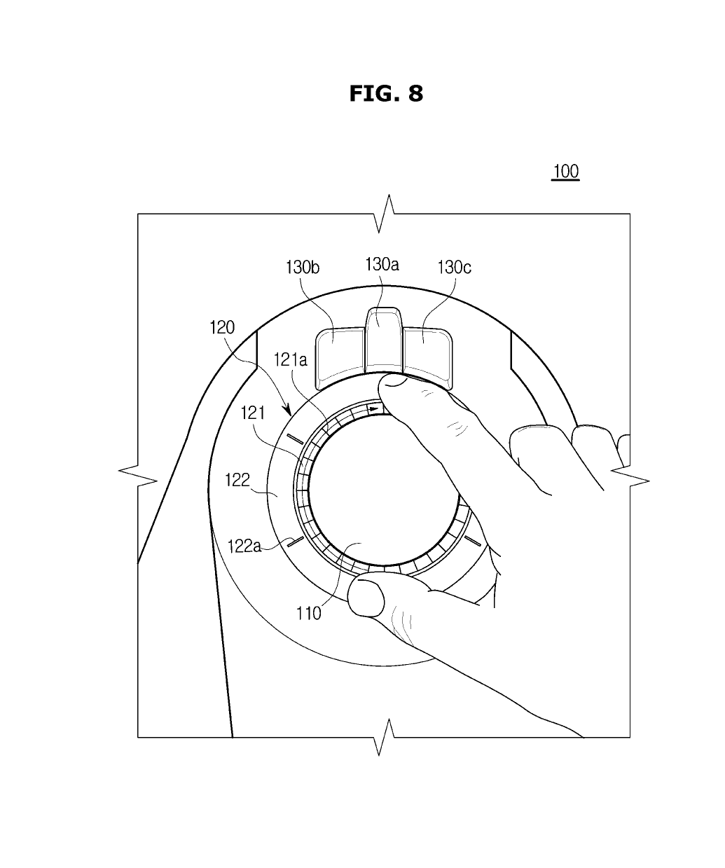

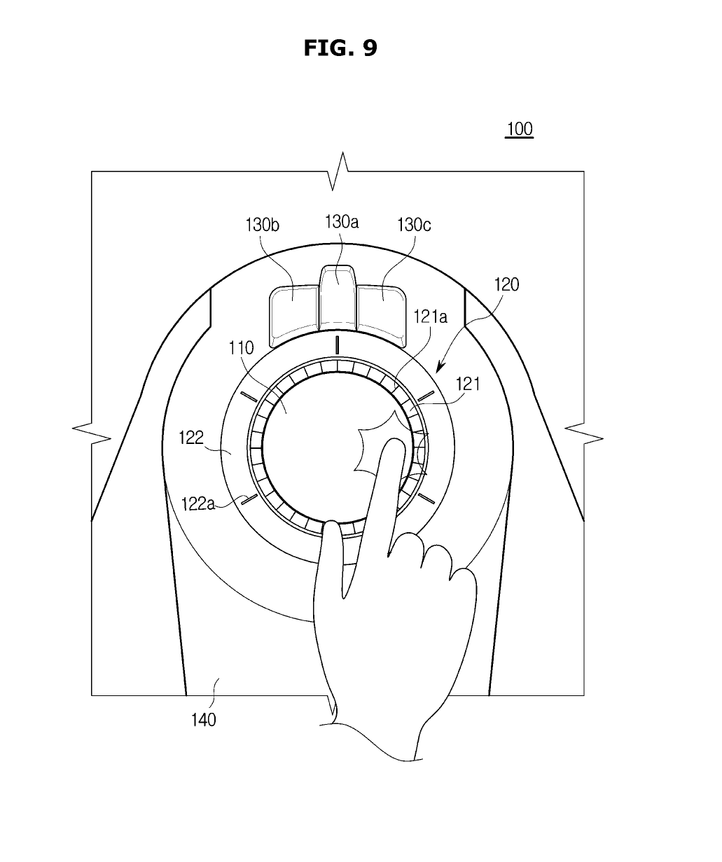

FIGS. 6 to 9 are views for describing a method of manipulating the touch input apparatus 100 according to an embodiment of the present disclosure. FIG. 6 is a top view of the touch input apparatus 100 for describing a method of inputting drag operation, FIG. 7 is a top view of the touch input apparatus 100 for describing a method of inputting touch and rotation operation, FIG. 8 is a top view of the touch input apparatus 100 for describing a method of inputting physical rotation operation, and FIG. 9 is a top view of the touch input apparatus 100 for describing a method of inputting tap operation.

FIG. 6 shows a dragging or flicking gesture in which a pointer moves from left to right. A user may make a dragging gesture on the touch portion 110 to input a predetermined command.

FIG. 7 shows a state when a user inputs touch and rotation operation by touching and rotating the inner area 121 of the wheel portion 120. If the inner area 121 of the wheel portion 120 is configured to recognize touch inputs, the user may rub the inner area 121 to input a predetermined command. Also, if the outer area 122 is configured to recognize touch inputs, the user may rub the outer area 122 to input a predetermined command.

Also, a rotation command input by the user may depend on a start location at which the pointer starts contacting and an end location at which the pointer is taken off.

FIG. 8 shows a state when a user rotates the wheel portion 120 while pressing the outer area 122 of the wheel portion 120. The user may physically rotate the wheel portion 120 to input a predetermined command. Or, the user may rotate the wheel portion 120 while pressing the inner area 121.

Also, the wheel portion 120 may provide the user with a feedback at predetermined angles. For example, whenever the wheel portion 120 is rotated by a predetermined angle, the wheel portion 120 may click to provide a feedback. Also, whenever the wheel portion 120 is rotated by a predetermined angle, the wheel portion 120 may vibrate.

FIG. 9 shows a state when a user presses the left area of the touch portion 110. The user may touch or physically press the touch portion 110 to input an operation command.

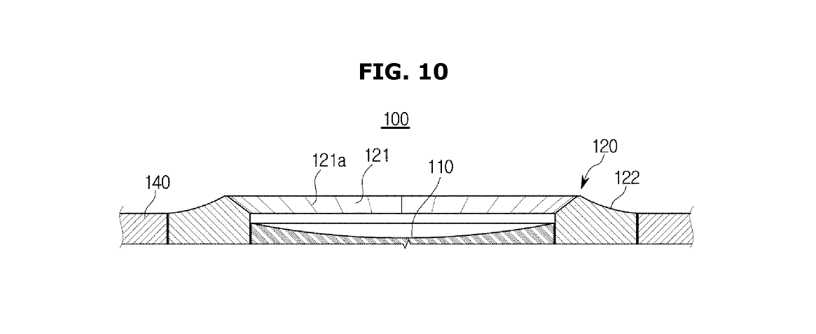

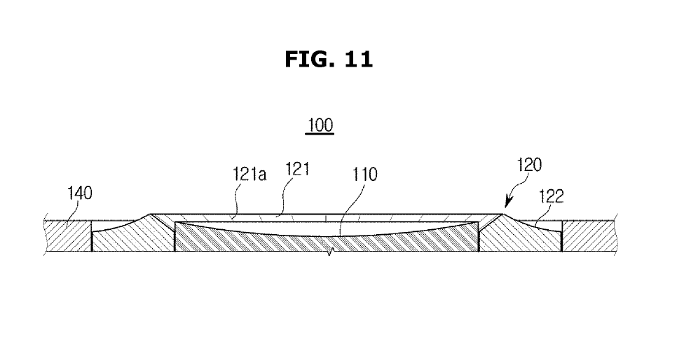

FIG. 10 is a cross-sectional view of the touch input apparatus 100 when the touch portion 110 is pressed, and FIG. 11 is a cross-sectional view of the touch input apparatus 100 when the wheel portion 120 is pressed.

Referring to FIG. 10, the touch portion 110 may be configured to be pressed. The touch portion 110 may be evenly pressed, or may be tilted to be partially pressed. For example, the touch portion 110 may be tilted in an up/down/left/right direction to be pressed, and different commands may be input according to the directions in which the touch portion 110 is tilted.

Referring to FIG. 11, the wheel portion 120 may be configured to be pressed. The wheel portion 120 may be evenly pressed, or may be tilted to be partially pressed. For example, the wheel portion 120 may be tilted in the up/down/left/right direction to be pressed, and different commands may be input according to the directions in which the wheel portion 120 is tilted.

Also, the touch portion 110 and the wheel portion 120 may share a single pressing structure (for example, a button), while being prevented from being pressed simultaneously. Accordingly, it is possible to prevent execution errors that may be generated when the user presses the touch portion 110 and the wheel portion 120 simultaneously by mistake. Also, if the touch portion 110 and the wheel portion 120 share a single pressing structure, a manufacturing cost can be reduced.

Hereinafter, a usage example of the wheel portion 120 will be described.

A user may rotate, when searching a list of the display, the wheel portion 120 to move a focus to locate it at a desired target, and then press the wheel portion 120 to select the target.

Also, the user may rotate the wheel portion 120 in a clockwise direction to zoom in a map, or rotate the wheel portion 120 in a counterclockwise direction to zoom out the map.

Also, the user may rotate the wheel portion 120 when a Home screen is displayed to move to a desired menu, and then press the wheel portion 120 to select the desired menu.

Also, the user may rotate the wheel portion 120 in a radio mode to adjust the frequency of the radio.

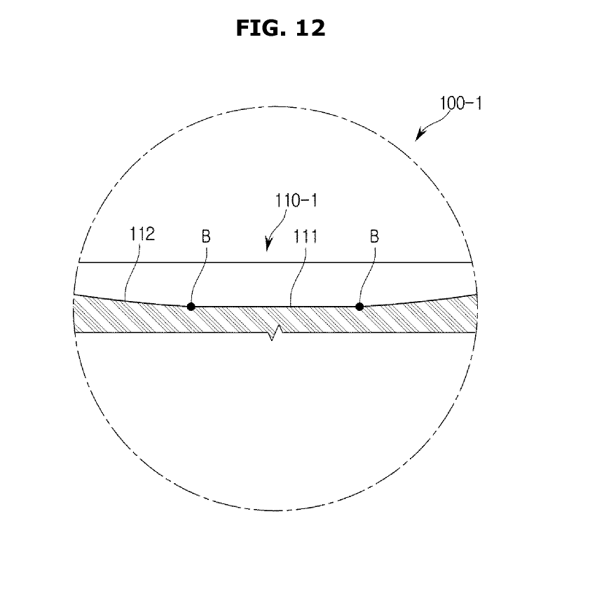

FIG. 12 shows a cross-sectional enlarged view of a touch portion 110-1 according to a first modified embodiment of the present disclosure.

The touch portion 110-1 according to the first modified embodiment of the present disclosure may be provided as a concavely curved surface having a flat center area 111 and a curved outer area 112. A boundary line B between the center area 111 and the outer area 112 may form a circle on a flat surface.

The touch portion 110-1 may provide different effects by adjusting a ratio of the width of the center area 111 to that of the outer area 112. For example, if the width of the center area 111 is relatively wider than that of the outer area 112, the center area 111 which is flat may be used as space for inputting a gesture such as a character, etc., and the outer area 112 which is curved may be used as space for inputting a circular gesture such as rolling, spinning, etc.

In contrast, if the width of the outer area 112 is relatively wider than that of the center area 111, the outer area 112 which is curved may be used as space for inputting a gesture, and the center area 111 may be used as an indicator for enabling a user to recognize the center of the touch portion 110-1.

A touch signal input to the center part 111 may be distinguished from that input to the outer part 112. For example, a touch signal input to the center part 111 may be a signal for the lower menu, and a touch signal input to the outer area 112 may be a signal for the upper menu.

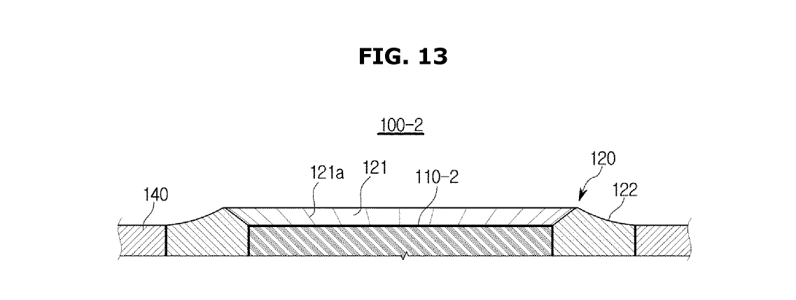

FIG. 13 shows a cross-sectional enlarged view of a touch portion 110-2 according to a second modified embodiment of the present disclosure.

The touch portion 110-2 according to the second modified embodiment of the present disclosure may be provided as a flat surface. Although the touch portion 110-2 is provided as a flat surface, the inner area 121 of the wheel portion 120 may be concavely curved so that the above-described effects can be provided.

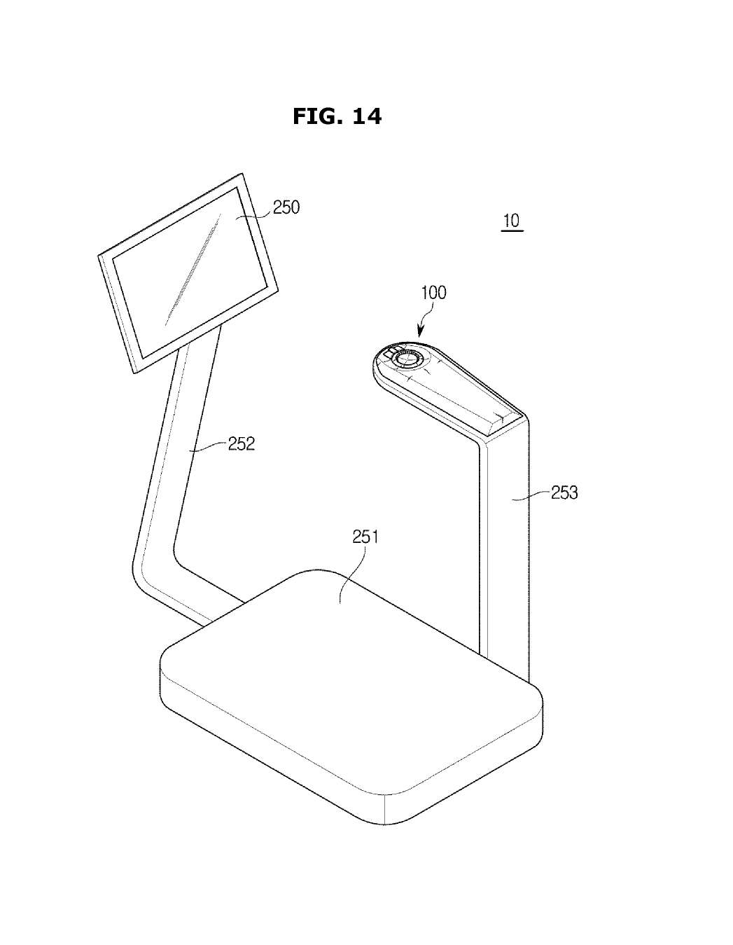

FIG. 14 is a perspective view of a health machine 10 in which the touch input apparatus 100 according to an embodiment of the present disclosure is installed.

The touch input apparatus 100 according to an embodiment of the present disclosure may be installed in the health machine 10. The health machine 10 may be medical equipment. The health machine 10 may include a main body 251 on which a user can stand, a display 250, a first connection portion 252 configured to connect the display 250 to the main body 251, the touch input apparatus 100, and a second connection portion 253 configured to connect the touch input apparatus 100 to the main body 251.

The main body 251 may measure various body state information including the user's weight. Also, the display 250 may display various image information including measured body state information, etc. Also, the user can manipulate the touch input apparatus 100 while looking at the display 250.

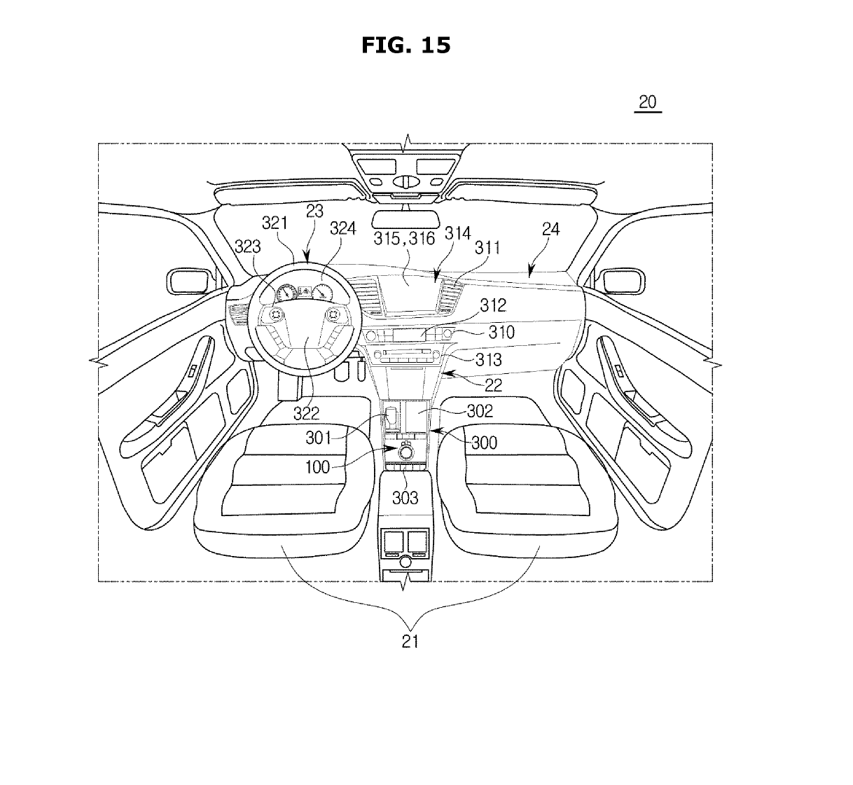

The touch input apparatus 100 may be installed in a vehicle 20 (see FIG. 15).

The vehicle 20 may be one of various kinds of machinery for transporting an object, such as humans, things, animals, etc., from a departure point to a destination. The vehicle 20 may include a car that travels on roads or rails, a vessel that sails the sea or river, and an airplane that flies the sky using the effects of the air.

The car that travels on the roads or rails can move in a predetermined direction by rotation of at least one wheel. Examples of the car may include a three-wheeled or four-wheeled vehicle, construction equipment, a two-wheeled vehicle, a motor bicycle, a bicycle, and a train running on a track.

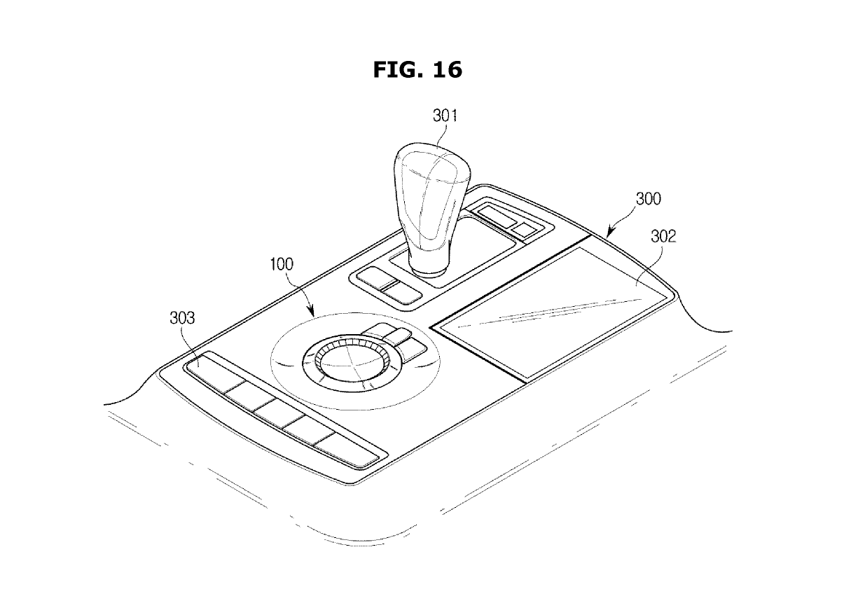

FIG. 15 shows the interior of the vehicle 20 in which the touch input apparatus 100 according to an embodiment of the present disclosure is installed, and FIG. 16 is a perspective view of a gear box 300 in which the touch input apparatus 100 according to an embodiment of the present disclosure is installed.

Referring to FIG. 15, the vehicle 20 may include seats 21 on which a driver, etc. sit, and a dashboard 24 in which the gear box 300, a center fascia 22, a steering wheel 23, etc. are installed.

In the center fascia 22, an air conditioner 310, a clock 312, audio system 313, Audio Video Navigation (AVN) system 314, etc. may be installed.

The air conditioner 310 may adjust the temperature, humidity, air quality, and flow of air inside the vehicle 20 to maintain the inside of the vehicle 20 pleasant. The air conditioner 310 may be installed in the center fascia 22, and may include at least one vent 311 for discharging air. In the center fascia 22, at least one button or dial for controlling the air conditioner 310, etc. may be provided. A user such as a driver may use the button provided on the center fascia 310 to control the air conditioner 310.

The clock 312 may be positioned around the button or dial for controlling the air conditioner 310.

The audio system 313 may include an operation panel on which a plurality of buttons for performing the functions of the audio system 313 are arranged. The audio system 313 may provide a radio mode for providing a radio function, and a media mode for reproducing audio files stored in various storage media.

The AVN system 314 may be embedded in the center fascia 22 of the vehicle 20, or may protrude from the dashboard 24. The AVN system 314 can integratively perform an audio function, a video function, and a navigation function according to a user's manipulation. The AVN system 314 may include an input unit 315 to receive a user command related to the AVN system 314, and a display 316 to display a screen related to the audio function, a screen related to the video function, or a screen related to the navigation function. Meanwhile, the audio system 313 may be omitted as long as functions of the audio system 313 are the same as those of the AVN system 314.

The steering wheel 23, which is used to change the driving direction of the vehicle 20, may include a rim 321 that is gripped by a driver, and a spoke 322 connected to a steering apparatus of the vehicle 20 and connecting the rim 321 to a hub of a rotation axis for steering. According to an embodiment, a controller 323 for controlling various systems (for example, the audio system 313) in the vehicle 20 may be mounted on the spoke 322.

Also, the dashboard 24 may further include an instrument panel 324 to inform a driver of driving speed, mileage, Revolutions Per Minute (RPM) of engine, an amount of oil, a temperature of cooling water, and various warnings, etc., during driving, and a globe box 325 to store various things.

The gear box 300 may be positioned between a driver seat and a passenger seat in the inside of the vehicle 20, and in the gear box 300, controllers that the driver needs to manipulate during driving may be installed.

Referring to FIG. 16, in the gear box 300, a gearshift 301 to shift gears of the vehicle 20, a display 302 to control the execution of the functions of the vehicle 20, and a button 303 to execute various apparatuses installed in the vehicle 20 may be installed. Also, in the gear box 300, the touch input apparatus 100 according to the embodiment of the present disclosure may be installed.

The touch input apparatus 100 according to the embodiment of the present disclosure may be installed in the gear box 300 so that a driver can manipulate the touch input apparatus 100 while keeping eyes forward during driving. For example, the touch input apparatus 100 may be positioned below the gearshift 301. Meanwhile, the touch input apparatus 100 may be installed in the center fascia 22, in the passenger seat, or in the back seat.

The touch input apparatus 100 may be electrically connected to displays installed in the vehicle 20 to allow the user to select or execute various icons displayed on the displays. The displays installed in the vehicle 20 may include the audio system 313, the AVN system 314, or the instrument panel 324. Also, the display 302 may be installed in the gear box 300, as necessary. Also, the display 302 may be electrically connected to a Head Up Display (HUD) or rearview mirrors.

For example, the touch input apparatus 100 may move a cursor displayed on the display, or execute an icon displayed on the display. The icon may include a main menu, a selection menu, a setting menu, etc. Also, the touch input apparatus 100 may be used to operate the navigation system, to set driving conditions of the vehicle 20, or to execute the peripherals of the vehicle 20.

In the touch input apparatus according to the embodiment of the present disclosure, by disposing the wheel portion along the edge of the touch portion, it is possible to diversify commands and provide the convenience of manipulation.

Also, compared to a case in which the touch portion and the wheel portion operate only as a touch input device without physically operating, it is possible to improve convenience and manipulation sensation.

Also, by configuring the wheel portion to be physically rotatable, it is possible to enable a user to feel analog sensitivity, while providing the user with a one-dimensional feeling of segmentation and a feeling of segmentation according to angle, thereby providing an immediate feedback according to rotation.

Also, in order to remove inconvenience that a user should move his/her finger to the touch portion to issue a select or release command after rotation operation if the wheel portion can perform only rotation operation, the wheel portion may be configured to be pressed so that the user can press the wheel portion to complete a select or release command without having to move his/her finger after rotation operation. Accordingly, it is possible to reduce a user's physical inconvenience and to simplify a manipulation method, thereby helping the user's intuitive recognition.

Also, in the case of typical knob type system, segmented operation was inevitable to rotate it one full turn or more, however, by using the wheel portion provided on a flat surface, a user can perform successive manipulation regardless of an angle of rotation.

Also, since the touch portion includes a concave (or engraved or depressed) structure, a user can get a good operation feeling and touch sensation when inputting a gesture. Also, since the touch portion is designed ergonomically, the touch input apparatus may not damage the joints of a user's wrist or the back of the user's hand even when the user uses the touch input apparatus for a long time.

Also, since the touch portion is lower than the adjacent portion, a user can intuitively recognize the touch area without looking at the touch portion, thereby improving the recognition rate of gestures.

Also, since the touch portion includes a concavely curved surface, a user can intuitively recognize where the user's finger is positioned on the touch portion, through a sense of inclination felt by the user's finger, when using the touch input apparatus even without putting his/her eyes on the touch input apparatus, that is, while looking at the display or keeping his/her eyes forward.

Accordingly, the user can easily input a gesture while looking at the display, without having to look at the touch input apparatus, and also, the user can input a precise gesture at an exact location, thereby improving the recognition rate of gestures.

Particularly, if the touch input apparatus according to the embodiment of the present disclosure is applied to a vehicle, the touch input apparatus may enable a driver to input an accurate gesture while keeping his/her eyes forward, when the user manipulates navigation system or audio system during driving.

Also, by forming gradations on the wheel portion so that a user can recognize the gradations through his/her tactile sensation, the user can intuitively recognize an angle of rotation. Accordingly, different signals can be input according to the angles of rotation, thereby improving the degree of freedom of manipulation while improving the accuracy of inputs.

Also, by differentiating the inclination of the touch portion from that of the wheel portion, the user can intuitively distinguish the touch portion from the wheel portion by touching.

Also, the touch portion may be configured to be pressed in various directions so that different functions can be performed according to the directions in which the touch portion is pressed, thereby quickly performing a command.

Although exemplary embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A touch input apparatus comprising:
a touch portion configured to receive a touch signal from a user; and
a wheel portion disposed along an edge of the touch portion;
wherein the wheel portion is rotatable with respect to the touch portion,
wherein the touch portion includes a concave structure.

2. The touch input apparatus according to claim 1, wherein the touch portion has a circular shape, and
the wheel portion surrounds a circumferential edge of the touch portion.

3. The touch input apparatus according to claim 1, wherein the wheel portion includes a convex structure.

4. The touch input apparatus according to claim 1, wherein the touch portion is deeper at an inner area relative to an outer area or is maintained at the same depth.

5. The touch input apparatus according to claim 1, wherein the touch portion includes a concavely curved surface whose inclination becomes gradually smaller toward a center of the concavely curved surface.

6. A touch input apparatus comprising:
a touch portion mounted on an installation surface and configured to receive a touch signal from a user; and
a wheel portion mounted on the installation surface along an edge of the touch portion and rotatable with respect to the touch portion.

7. The touch input apparatus according to claim 6, wherein the wheel portion is configured to be pressed.

8. The touch input apparatus according to claim 7, wherein the wheel portion is configured to be tilted.

9. The touch input apparatus according to claim 6, wherein the wheel portion is pressed or tilted by pressure applied by a user to input a signal.

10. The touch input apparatus according to claim 7, wherein the touch portion is configured to be pressed with respect to the wheel portion.

11. The touch input apparatus according to claim 10, wherein the wheel portion and the touch portion are configured to be pressed by a single button structure, while being prevented from being pressed simultaneously.

12. The touch input apparatus according to claim 3, wherein the wheel portion includes an inner area extending upward from the circumference of the touch portion, and an outer area extending downward from a top of the inner area.

13. The touch input apparatus according to claim 12, wherein the inner area includes an inclined surface inclined downward toward the touch portion.

14. The touch input apparatus according to claim 12, wherein the outer area includes a concavely curved surface.

15. The touch input apparatus according to claim 1, wherein the wheel portion is configured to receive a touch signal from the user, and
the touch portion and the wheel portion receive touch signals, independently.

16. The touch input apparatus according to claim 1, wherein the wheel portion includes a plurality of gradations that are engraved or embossed.

17. The touch input apparatus according to claim 1, further comprising a wrist supporting portion formed at a part of the wheel portion and supporting the user's wrist, wherein the wrist supporting portion is positioned higher than a touch surface of the touch portion.

18. A vehicle comprising the touch input apparatus according to claim 1, a display apparatus, and a controller configured to operate the display apparatus according to an input signal input to the touch input apparatus.

19. The vehicle according to claim 18, wherein the controller converts a gesture input to the touch input apparatus into an input signal, and transmits an operation signal to display operation indicated by the input signal on the display apparatus.

20. The vehicle according to claim 19, wherein the touch input apparatus is installed in a gear box.
